(19) United States
(12) Patent Application Publication
(10) Pub. No.: US 2012/0208389 A1
(43) Pub. Date: Aug. 16, 2012

(54) CONNECTOR

(75) Inventors: Naohiro NAKATSUJI, Kariya-shi (JP); Masao TADA, Kariya-shi (JP); Shinichiro KOMAKI, Kariya-shi (JP); Akihiro TANAKA, Yao-shi (JP)

(73) Assignees: HOSIDEN CORPORATION, Yao-shi (JP); TOYOTA BOSHOKU KABUSHIKI KAISHA, Kariya-shi (JP)

(21) Appl. No.: 13/306,016

(22) Filed: Nov. 29, 2011

(30) Foreign Application Priority Data
Feb. 10, 2011 (JP) 2011-026703

(51) Int. Cl. H01R 13/62

(52) U.S. Cl. 439/345

(57) ABSTRACT

The invention provides a connector including first and second conductive parts and a biasing device. The first and second conductive parts are opposed to each other so as to hold a flexible electric conductor therebetween. The first conductive part includes a locking hole or locking recess, and the second conductive part includes a locking projection of pointed shape. The locking projection is configured to pass through the electric conductor and be received in the locking hole or locking recess when the first and second conductive parts hold the electric conductor. The biasing device includes a clamp of generally C shape to hold the first and second conductive parts holding the electric conductor.

The present application claims priority under 35 U.S.C. §119 of Japanese Patent Application No. 2011-026703 filed on Feb. 10, 2011, the disclosure of which is expressly incorporated by reference herein in its entity.

### BACKGROUND OF THE INVENTION

1. Field of the Invention

The present invention relates to connectors that are connectable to flexible electric conductors such as conductive fabrics.

1. Description of the Related Art

A conventional connector disclosed in Japanese Unexamined Patent Publication No. 2008-135222 includes first and second plates, coupled openably and closably, and a conductive metal plate fixed to the first plate. The conductive metal plate is provided with a plurality of claws to penetrate a locating tape (flexible electric conductor) to be received in a plurality of holes in the second plate. The claws of the conductive metal plate penetrate the locating tape, so that the conductive metal plate is electrically connected to the locating tape.

The connector maintains electrical connection with the locking claws on the first plate engaged with the locking holes in the second plate, by having the claws of the conductive metal plate penetrate the locating tape and inserting them into the holes of the second plate. When the locating tape is twisted, its flexibility may cause disengagement between the locking claws and the locking holes, so that the connector may lose electrical connection with the locating tape.

### SUMMARY OF INVENTION

The present invention has been conceived in view of the above circumstances. The invention provides a connector that can maintain electrical connection with a flexible electric conductor even when the electric conductor is twisted.

A first connector of the present invention includes first and second conductive parts and a biasing device. The first and second conductive parts are opposed to each other so as to hold a flexible electric conductor therebetween. The first conductive part includes a locking hole or locking recess, and the second conductive part includes a locking projection of pointed shape. The locking projection is configured to pass through the electric conductor and be received in the locking hole or locking recess when the first and second conductive parts hold the electric conductor. The biasing device includes a clamp of generally C shape to hold the first and second conductive parts holding the electric conductor.

A second connector of the invention includes first and second conductive parts that are opposed to each other so as to hold a flexible electric conductor therebetween; first and second bodies fixed to the first and second conductive parts, respectively; and a biasing device including a clamp of generally C shape to hold the first and second conductive parts holding the electric conductor. At least one of the first body and the first conductive part has a locking hole or locking recess. At least one of the second body and the second conductive part has a locking projection of pointed shape. The locking projection is configured to pass through the electric conductor and be received in the locking hole or locking recess when the first and second conductive parts hold the electric conductor.

In the first and second connectors, the locking projection is configured to pass through the electric conductor and be received in the locking hole or recess when the first and second conductive parts hold the electric conductor. The first and second conductive parts, held by the clamp, can keep holding the electric conductor securely therebetween even when the electric conductor is twisted. In addition, the first and second connectors have improved tension strengths with respect to the electric conductor because the locking projection is configured to pass through the electric conductor and be received in the locking hole or the locking recess. Received in the locking hole or recess, the locking projection is less likely to deform if placed under tension by the electric conductor pulled.

The first connector may further include first and second bodies fixed to the first and second conductive parts, respectively. The first and second bodies may be provided with first and second accommodating recesses, respectively, to accommodate the biasing device. The second connector may also be configured such that the first and second bodies are provided with first and second accommodating recesses, respectively, to accommodate the biasing device.

According to these aspects of the invention, as the biasing device is accommodated in the first and second accommodating recesses of the first and second bodies, it is possible to prevent the interference of the biasing device from outside. It is thus possible to prevent accidental disengagement of the biasing device from the first and second conductive parts due to such interference from outside.

The first and second connectors may each further include an engaging mechanism. In this case, the first and second conductive parts may each further include a first face, being abuttable on the electric conductor, and a second face, being an opposite face of the first face.

The clamp may include first and second arms being elastically abuttable on the second faces of the first and second conductive parts, respectively. The engaging mechanism may be configured to engage the first and second arms with the first and second conductive parts, respectively, in a state where the first and second arms elastically abut the second faces of the first and second conductive parts. According to this aspect of the invention, as the engaging mechanism can engage the first and second arms of the clamp with the first and second conductive parts in a state where the first and second arms elastically abut the second faces of the first and second conductive parts, the clamp has a further improved holding force with respect to the first and second conductive parts. As a result, the connectors have further improved tension strengths with respect to the electric conductor.

The engaging mechanism may include first and second steps, the first and second steps being provided in the first and second conductive parts, respectively, and configured to engage with the first and second arms, respectively. This aspect of the invention makes it possible to detachably attach the biasing device to the first and second conductive parts with ease because the biasing device can be engaged and fixed in position simply by having the first and second arms climb over the first and second steps.

The engaging mechanism may include first and second projections provided in the first and second conductive parts, respectively, and first and second holes provided in the first and second arms, respectively; or alternatively, the engaging mechanism may include first and second holes provided in the first and second conductive parts, respectively, and first and second projections provided in the first and second arms, respectively. In either case, the first and second projections may be configured to engage with the first and second holes. This aspect of the invention further improves a holding force of the clamp with respect to the first and second conductive parts because the first and second projections are engaged in the first and second holes.

At least one of the first and second conductive parts may further include a connecting portion that is connectable to a cable. This aspect of the invention eases the external connection of the connector through the use of the connecting portion to connect the cable.

The first body may include a hinge shaft and the second body may include a hinge hole, or alternatively the first body may include a hinge hole and the second body may include a hinge shaft. The hinge shaft may be configured to fit in the hinge hole and is of a tubular shape. The hinge shaft and the hinge hole may be configured to allow the cable to pass therethrough so as to connect the cable with the connecting portion.

This aspect of the invention eases the routing of the cable because the hinge shaft and the hinge hole allow the cable to pass therethrough and to connect to the connecting portion.

At least one of the first and second conductive parts may further include a holding portion to hold the cable. According to this aspect of the invention, the first and second connectors have improved tension strengths with respect to the cable because the cable is held in the holding portion.

The first faces of the first and second conductive parts may preferably be provided with projections. According to this aspect of the invention, as the projections on the first faces of the first and second conductive parts are brought into contact with the electric conductors, the first and second conductive parts have increased friction resistance with the electric conductor, improving the tension strengths of the first and second connectors with respect to the electric conductor. In addition, the projections on the first faces of the first and second conductive parts elastically contact with the electric conductor, so that the first and second conductive parts are stabilized in contact resistance value with respect to the electric conductor, thereby stabilizing the connection of the first and second connectors.

Each of the projections is preferably of square cone shape. According to this aspect of the invention, the increase in surface area of the projections further increases the friction resistance of the first and second conductive parts and thereby the tension strengths of the first and second connectors with respect to the electric conductor. In addition, the increase in surface areas of the projections stabilize the contact resistance value of the first and second conductive parts with respect to the electric conductor, thereby stabilizing the connection of the connectors.

A plurality of locking projections may be arranged outside the first face of the second conductive part. The locking hole or locking recess may include a plurality of locking holes or locking recess arranged in opposite outer ends of the first face of the first conductive part.

Each locking projection may be provided with a barb. According to this aspect of the invention, the barb makes the locking projection passed through the electric conductor less likely to fall off. Therefore, the first and second connectors have further improved tension strengths with respect to the electric conductor. In addition, when the barb is locked in the locking hole or recess, the first and second conductive parts will be further improved in holding force with respect to the electric conductor.

The first and second connectors may each further include a locking mechanism to lock the first body with the second body in the state where the first and second conductive parts hold the electric conductor therebetween. For example, the locking mechanism may include a locking claw provided on one of the first and second bodies, and a locking hole or locking recess formed in the other of the first and second bodies and configured to lock the locking claw in the state where the first and second conductive parts hold the electric conductor therebetween. According to these aspects of the invention, the locking mechanism locks the first body with the second body to maintain the state where the first and second conductive parts hold the electric conductor therebetween.

### BRIEF DESCRIPTION OF DRAWINGS

FIG. 1A is a front top right perspective view of a connector in a closed state according to a first embodiment of the present invention.

FIG. 1B is a rear top left perspective view of the connector in the closed state.

FIG. 1C is a plan view of the connector in the closed state.

FIG. 1D is a bottom view of the connector in the closed state.

FIG. 1E is a front top right perspective view of the connector in an open state.

FIG. 2A is a cross-sectional view of the connector taken along line 2A-2A in FIG. 1A.

FIG. 2B is a cross-sectional view of the connector taken along line 2B-2B in FIG. 1A.

FIG. 3A is a front bottom left perspective view of a first body and a first conductive part of the connector.

FIG. 3B is a front top right perspective view of a second body and a second conductive part of the connector.

FIG. 4 is an exploded, front top right perspective view of the connector.

FIG. 5A is a rear top left perspective view of the first body of the connector.

FIG. 5B is a rear bottom right perspective view of the first body of the connector.

FIG. 6A is a rear top left perspective view of the second body of the connector.

FIG. 6B is a rear bottom right perspective view of the second body of the connector.

FIG. 7A is a rear top left perspective view of the first conductive part of the connector.

FIG. 7B is a rear bottom right perspective view of the first conductive part of the connector.

FIG. 8A is a rear top left perspective view of the second conductive part of the connector.

FIG. 8B is a rear bottom right perspective view of the second conductive part of the connector.

FIG. 9A is a front top right perspective view of a connector in a closed state according to a second embodiment of the invention.

FIG. 9B is a front top right perspective view of the connector in an open state.

FIG. 10A is an exploded, front top right perspective view of the connector.

FIG. 10B is an exploded, front bottom left perspective view of the connector.

FIG. 11A is a front bottom left perspective view of a first body and a first conductive part of the connector.

FIG. 11B is a front top right perspective view of a second body and a second conductive part of the connector.

### DESCRIPTION OF EMBODIMENTS

The following is a detailed description of first and second embodiments of the present invention. This is for illustrative purposes only, and not limitation.

### First Embodiment

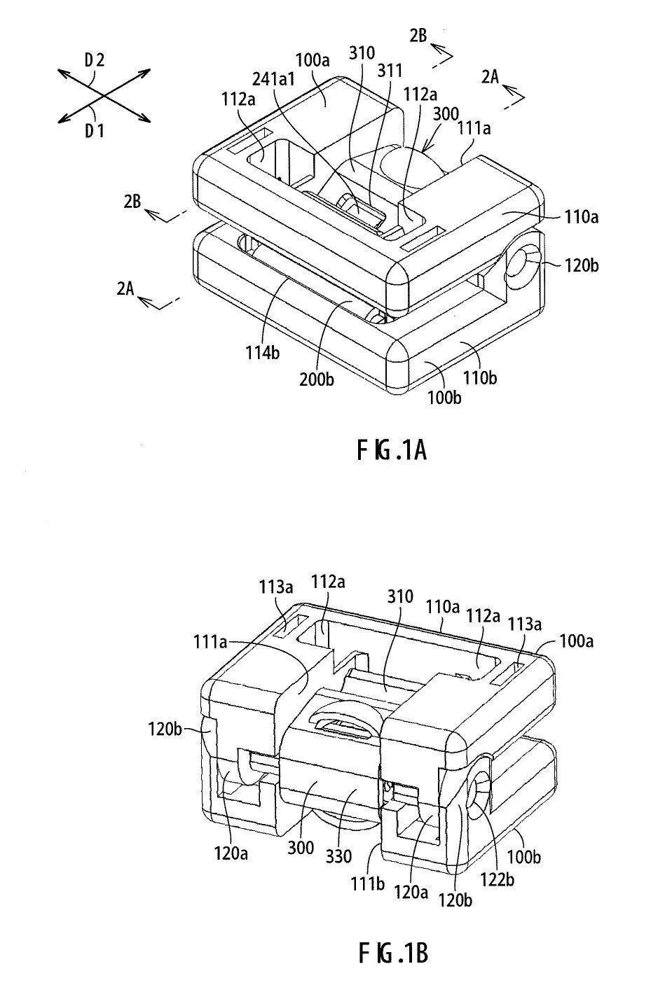

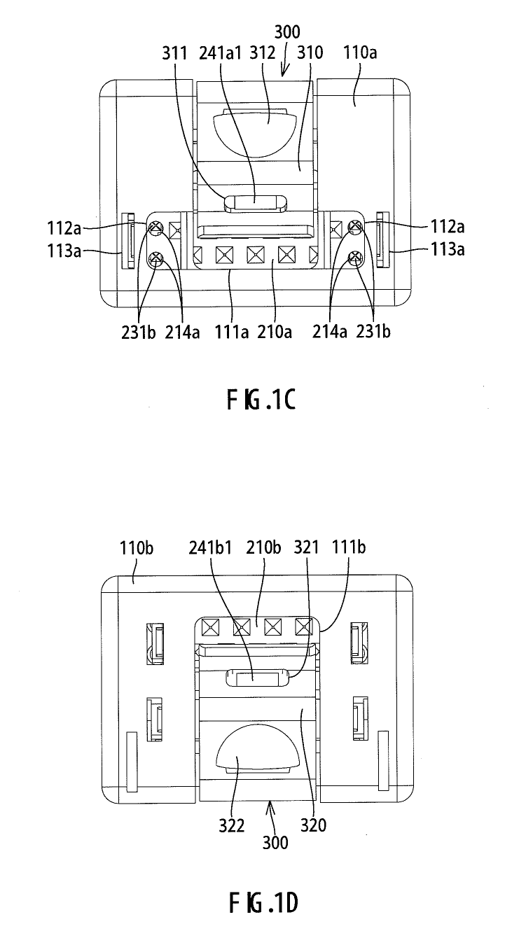

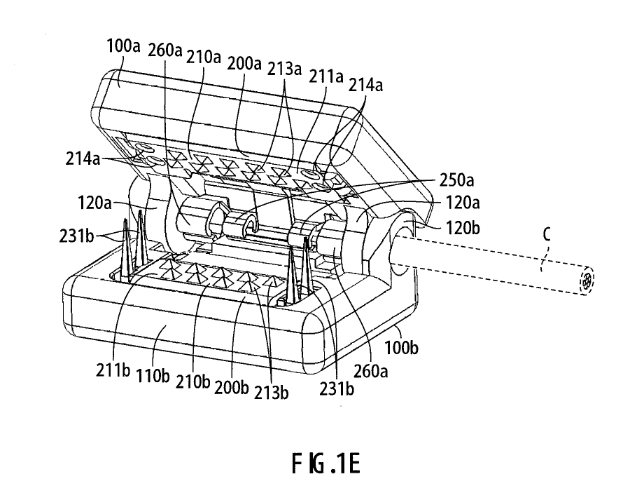

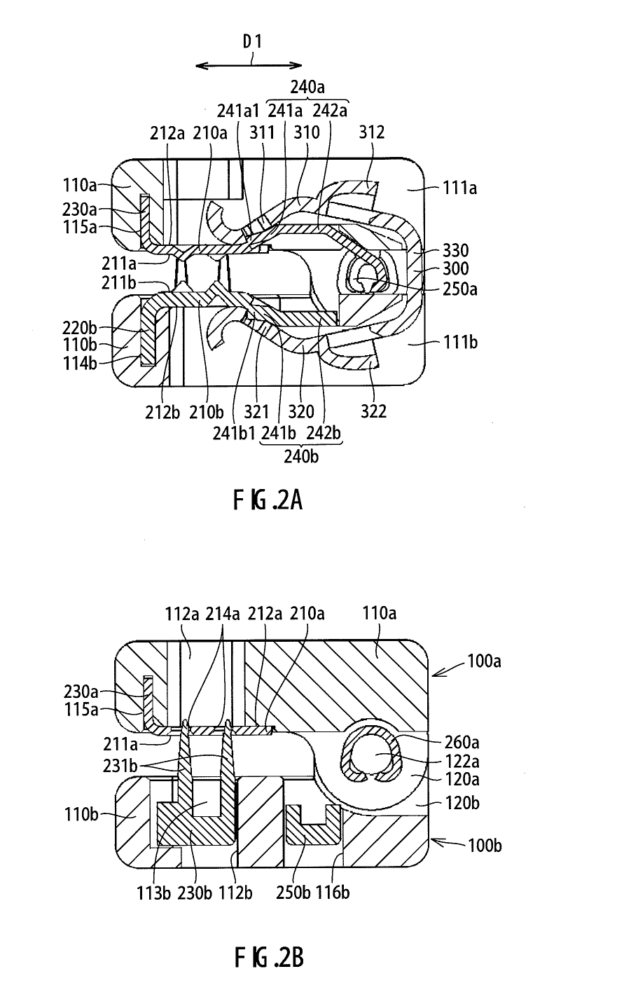

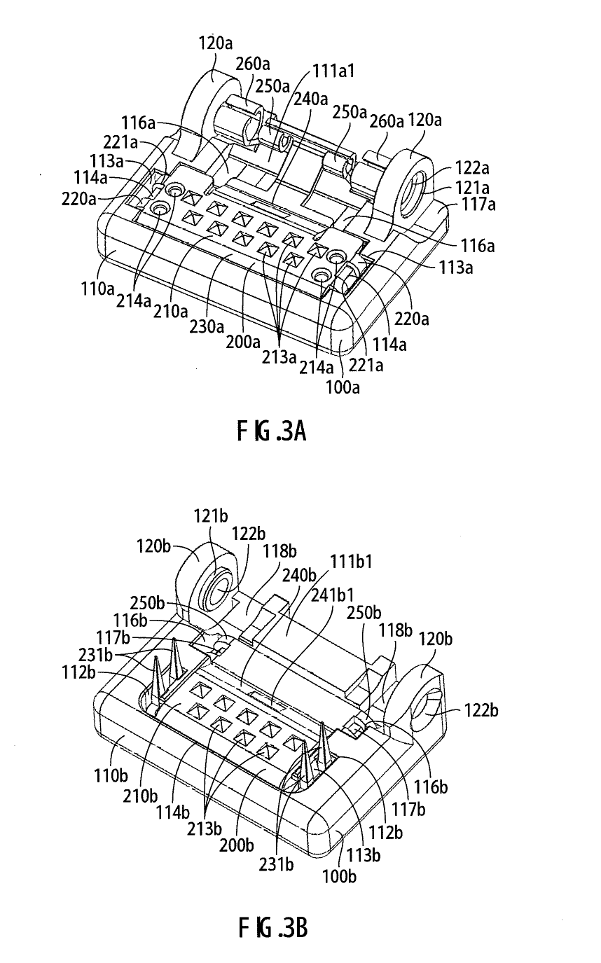

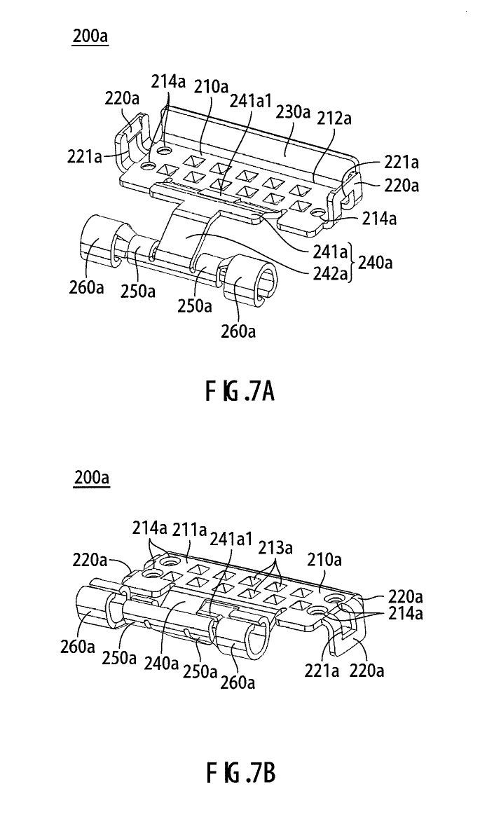

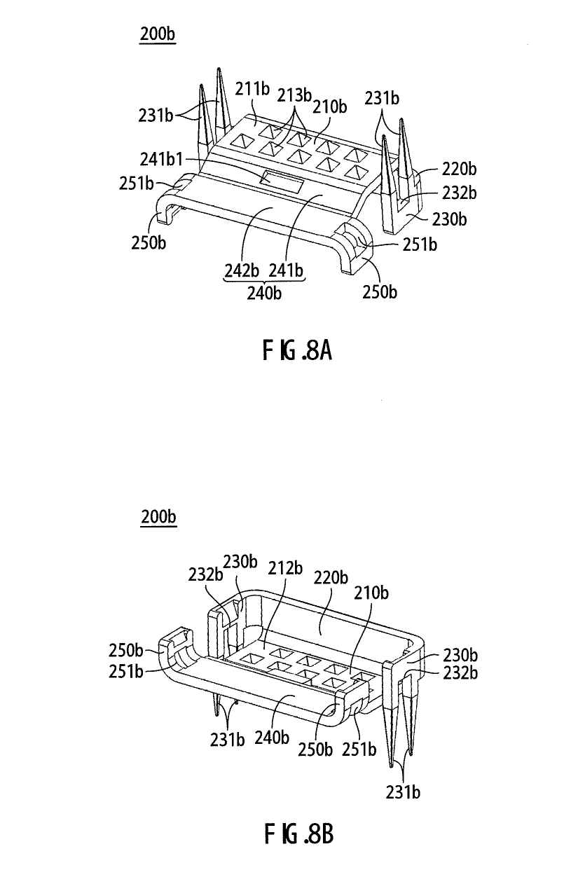

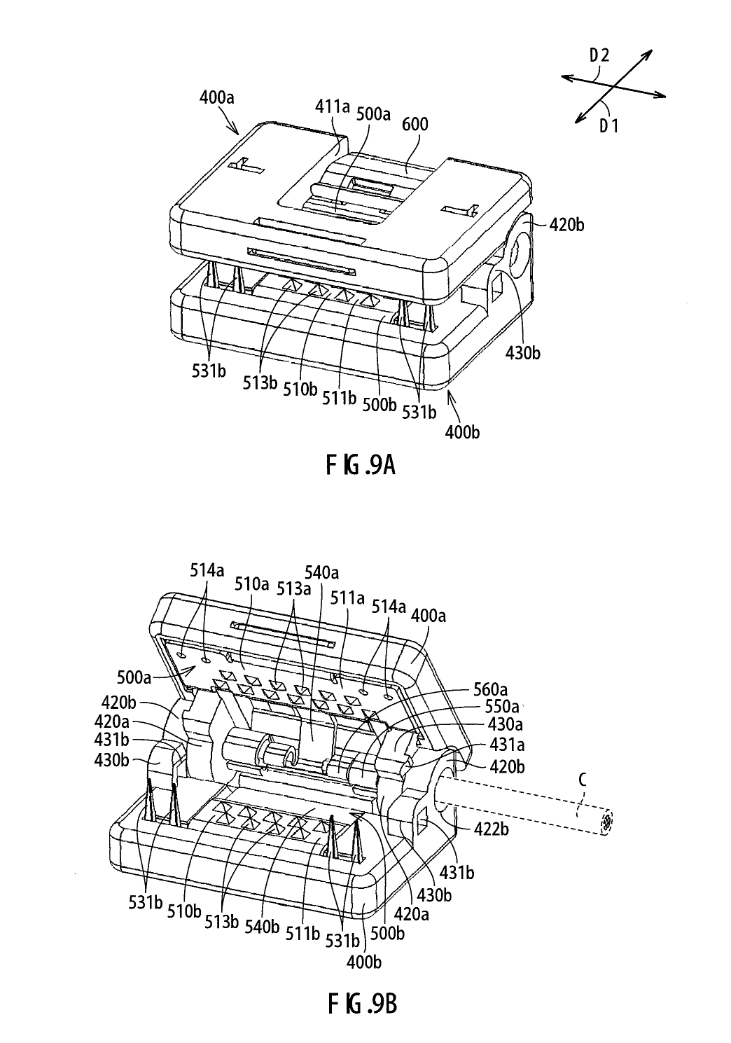

The first embodiment of the invention is described in detail below, with reference to FIGS. 1A to 8B. The connector herein is connectable to a flexible conductive fabric (electric conductor), not shown, and a cable C. As shown in FIGS. 1A to 2B, the connector includes bodies 100a and 100b (first and second bodies), conductive parts 200a and 200b (first and second conductive parts), and a spring clip 300 (biasing device). These elements of the connector will be described in detail below. It should be noted that FIGS. 1A, 2A, and 4 show directions D1 and D2 for the convenience of explanation of the first embodiment. D1 is a fore-and-aft direction of the connector, and D2 is a lateral direction that is orthogonal to the fore-and-aft direction D1.

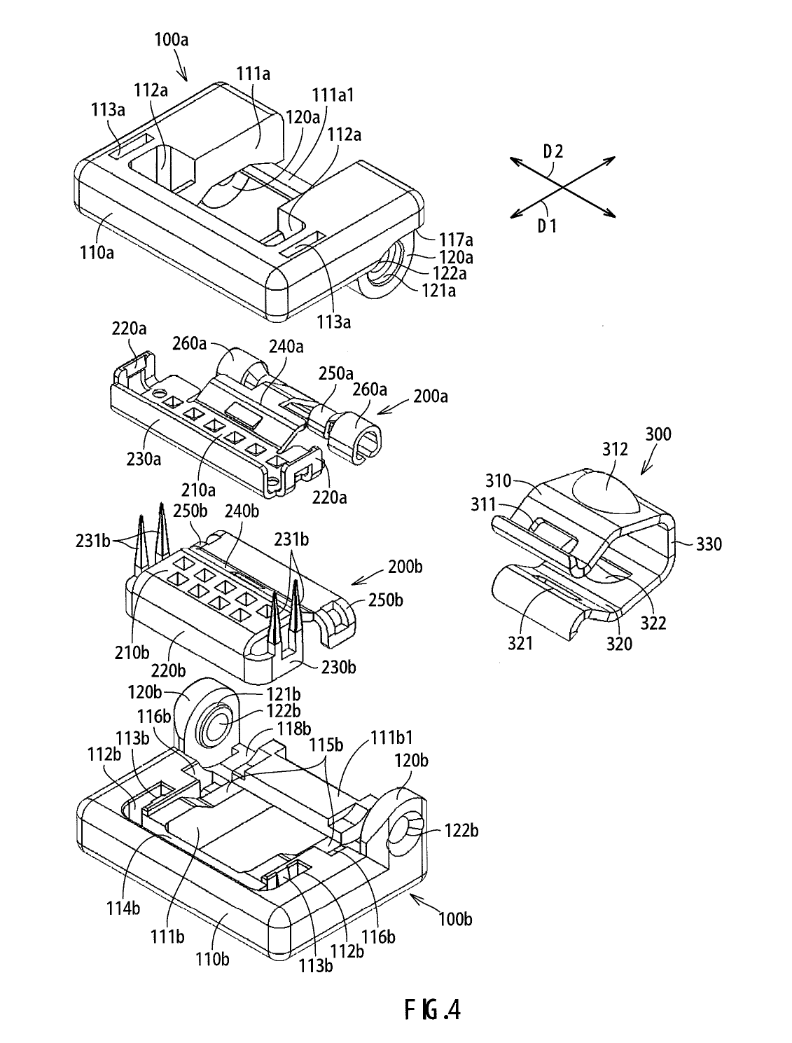

The body 100a is an injection mold product made of an insulating resin as shown in FIGS. 3A, 4, 5A, and 5B. The body 100a has a generally rectangular block 110a and a pair of ring-shaped hinge protrusions 120a. A rectangular accommodating recess 111a is formed in a center of the block 110a. The accommodating recess 111a passes through the block 110a in its thickness direction such that a rear side in the fore-and-aft direction D1 of the block 110a is open. A pressing portion 111a1 bridges rear ends of walls extending in the fore-and-aft direction D1 of the accommodating recess 111a. An upper face of the pressing portion 111a1 slopes downward to the rear side in the fore-and-aft direction D1. The pressing portion 111a1 is to be disposed on the rear side in the fore-and-aft direction D1 of a step 240a (to be described) of the conductive part 200a.

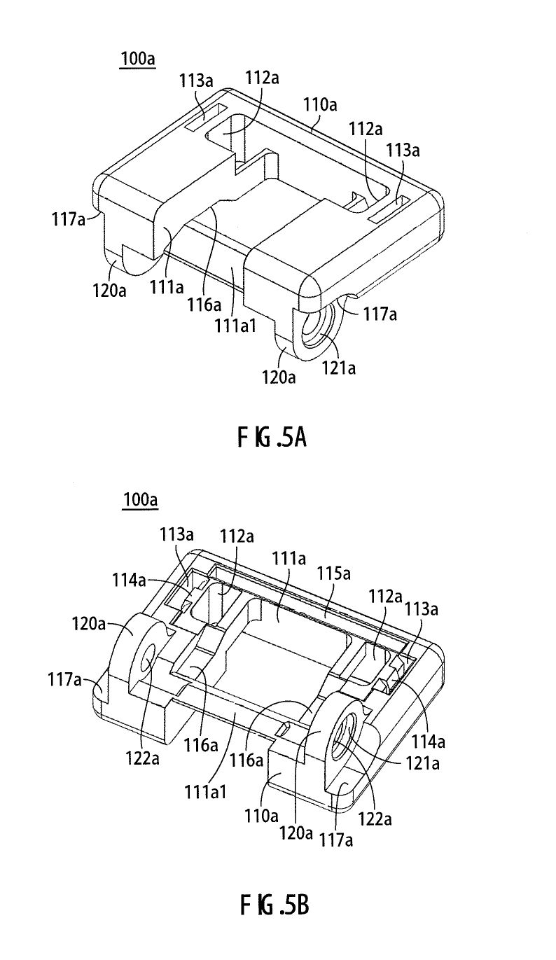

A pair of generally rectangular through holes 112a is formed outside the accommodating recess 111a at a front end of the block 110a, passing through the block 110a in the thickness direction. Outside the through holes 112a of the block 110a is formed a pair of generally rectangular locking slits 113a passing through the block 110a in the thickness direction. As shown in FIG. 5B, the locking slits 113a have protrusions 114a on their respective walls on the inner side. A rectangular front slit 115a is formed in front of the accommodating recess 111a and the through holes 112a of the block 110a. A pair of side recesses 116a is formed behind the through holes 112a of the block 110a and in communication with the accommodating recess 111a. In rear corners in the rear side in the fore-and-aft direction D1 of the block 110a, a pair of indentions 117a is formed to avoid the interference of the block 110a with hinge protrusions 120b (to be described) of the body 100b.

The pair of hinge protrusions 120a are located inside the indentions 117a in the rear end of the block 110a. The hinge protrusions 120a centrally have hinge holes 121a and insertion holes 122a, with the insertion holes located inside the hinge protrusions 120a. The hinge holes 121a and the insertion holes 122a are concentric and communicate with each other. The hinge holes 121a and the insertion holes 122a serve as through holes in the lateral direction D2 of the hinge protrusions 120a. The inside diameter of the insertion holes 122a is smaller than the inside diameter of the hinge holes 121a and is slightly larger than the outside diameter of the cable C. In other words, the cable C is insertable into the hinge hole 121a and the insertion hole 122a as shown in FIG. 1E.

The body 100b is an injection mold product made of an insulating resin as shown in FIGS. 3B, 4, 6A, and 6B. The body 100b has a generally rectangular block 110b and the pair of ring-shaped hinge protrusions 120b. A rectangular accommodating recess 111b is formed in the center of the block 110b. The accommodating recess 111b passes through the block 110b in its thickness direction such that a rear side in the fore-and-aft direction D1 of the block 110b is open. A pressing portion 111b1 bridges rear ends of walls extending in the fore-and-aft direction D1 of the accommodating recess 111b. A lower face of the pressing portion 111b1 slopes upward to the rear side in the fore-and-aft direction D1. The pressing portion 111b1 is to be disposed on the rear side in the fore-and-aft direction D1 of a step 240b (to be described) of the conductive part 200b.

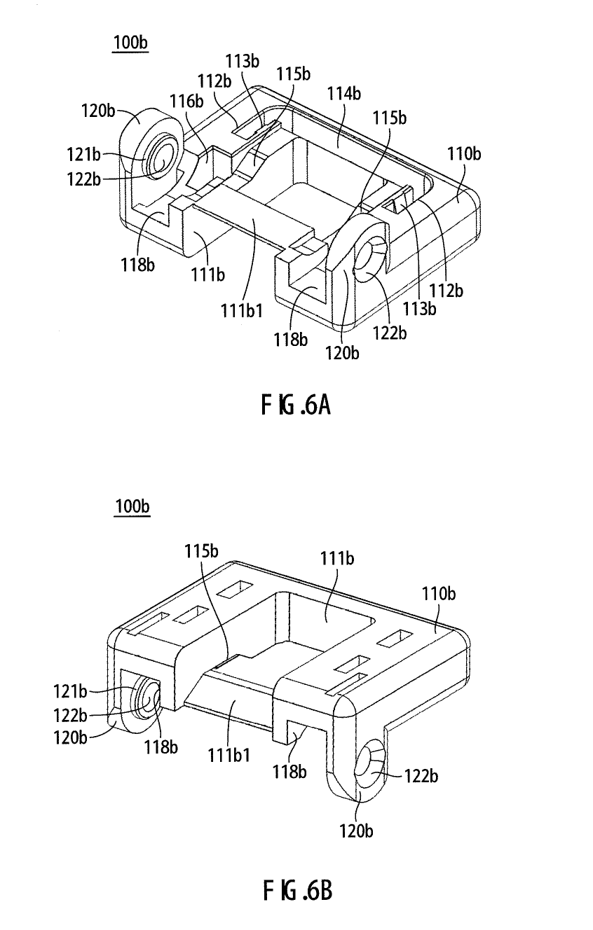

A pair of generally rectangular front locking holes 112b is formed outside the accommodating recess 111b at a front end of the block 110b, passing through the block 110b in the thickness direction. As shown in FIGS. 4 and 6A, the front locking holes 112b have front protrusions 113b on their respective walls on the inner side. A rectangular front slit 114b is formed in front of the accommodating recess 111b and the front locking holes 112b of the block 110b. Outer ends of the front slit 114b communicate with the respective front locking holes 112b. In the middle of the block 110b, there is formed a pair of side recesses 115b outside the accommodating recess 111b and in communication with the accommodating recess 111b. Further, a pair of generally rectangular rear locking holes 116b are provided outside the side recesses 115b of the block 110b. The rear locking holes 116b have rear protrusions 117b on their respective walls on the inner side as shown in FIG. 3B. Behind the rear locking holes 116b of the block 110b, a pair of hollows 118b is formed to avoid the interference of the block 110b with the hinge protrusions 120a of the body 100a.

The pair of hinge protrusions 120b are located outside the hollows 118b of the block 110b. The distance between the inner faces of the hinge protrusions 120b is substantially the same as the distance between the outer faces of the hinge protrusions 120a. Tubular hinge shafts 121b project from the inner faces of the hinge protrusions 120b. When the hinge shafts 121b fit into the hinge holes 121a of the hinge protrusions 120a, the bodies 100a and 100b will be hinged together openably and closably. FIGS. 1A and 1B show a closed state of the bodies 100a and 100b (that is, a closed state of the connector), and FIG. 1E shows an open state of the bodies 100a and 100b (that is, an open state of the connector). The hinge protrusions 120b have receiving holes 122b passing through the hinge protrusions 120b and the hinge shafts 121b in the lateral direction D2. The inside diameter of the receiving holes 122b is slightly larger than the outside diameter of the cable C, so that the cable C is insertable into the insertion holes 122b as shown in FIG. 1E.

As shown in FIGS. 3A, 4, 7A, and 7B, the conductive part 200a is configured of a metal plate having electrical conductivity. The conductive part 200a has a main plate 210a, side locking pieces 220a, a front plate 230a, the step 240a (a first step of an engaging mechanism), a pair of connecting portions 250a, and a pair of holding portions 260a. The main plate 210a is a generally rectangular plate, and it has a first face 211a (a first face of the first conductive part) and a second face 212a (a second face of the first conductive part) being the opposite face of the first face 211a. The first face 211a is to be brought into contact with the conductive fabric. A plurality of projections 213a of square pyramid shape are disposed in a zigzag manner in the middle of the first face 211a. Two locking holes 214a, aligned in the fore-and-aft direction D1, are formed in each end in the lateral direction D2 of the main plate 210a (each end of the first face 211a) As shown in FIG. 3A, the main plate 210a is placed on an inner face (i.e. the face facing the body 100b) of the body 100a so as to cover the front portion in the fore-and-aft direction D1 of the accommodating recess 111a and the pair of through holes 112a. The second face 212a of the main plate 210a is partly exposed, particularly in the middle through the accommodating recess 111a and in the opposite ends in the lateral direction D2 through holes 112a. The locking holes 214a of the main plate 210a communicate with the through holes 112a.

The pair of side locking pieces 220a are provided at ends in the lateral direction D2 of the main plate 210a. The side locking pieces 220a are bent substantially at a right angle to the main plate 210a and extend upward. Generally rectangular locking holes 221a are formed centrally in the side locking pieces 220a. The side locking pieces 220a are to be inserted into the locking slits 113a of the body 100a, while the protrusions 114a of the body 100a are to be locked in the locking holes 221a of the side locking pieces 220a, such that the conductive part 200a is fixed inside the body 100a.

The front plate 230a is provided at a distal end of the main plate 210a. The front plate 230a is bent substantially at a right angle to the main plate 210a and extends upward, i.e. in the same direction as the side locking pieces 220a. The front plate 230a is to be inserted into the front slit 115a of the body 100a.

The step 240a is continuous with a rear end of the main plate 210a. The step 240a has an inclined plate 241a and an arm plate 242a. The inclined plate 241a extends at an angle to the main plate 210a and slopes upward to the rear side of the fore-and-aft direction D1 (see FIG. 2A). The inclined plate 241a is accommodated at its end portions in the lateral direction D2 in the side recesses 116a of the body 100a and exposed in its middle portion through the accommodating recess 111a of the body 100a. The middle portion of the inclined plate 241a is provided with a projected piece 241a1 (a first projection). The arm plate 242a is a rectangular plate continuous with the rear center of the inclined plate 241a, and it has a smaller width than the inclined plate 241a sloping downward to the rear side in the fore-and-aft direction D1. The arm plate 242a is also exposed through the accommodating recess 111a.

The pair of connecting portions 250a are tubularly curved plates continuous with opposite ends of the rear end of the step 240a. The outer sides of the connecting portions 250a are continuous with the holding portions 260a, which are tubularly curved plates. The connecting portions 250a and the holding portions 260a are arranged between the hinge protrusions 120a of the body 100a such that they are substantially concentric with the hinge holes 121a and the insertion holes 122a of the hinge protrusions 120a. In other words, the connecting portions 250a, the holding portions 260a, the hinge holes 121a, and the insertion holes 122a are arranged along the lateral direction D2 and communicate with each other. The inside diameters of each connecting portion 250a is slightly larger than the outside diameter of a core wire of the cable C. The inside diameter of each holding portion 260a is slightly larger than the outside diameter of the cable C. That is, as shown in FIG. 1E, the cable C is insertable into the holding portion 260a, and the core wire of the cable C is insertable into the connecting portion 250a.

As shown in FIGS. 3B, 4, 8A, and 8B, the conductive part 200b is configured of a metal plate having electrical conductivity. The conductive part 200b has a main plate 210b, a front plate 220b, a pair of side plates 230b, a step 240b (a second step of the engaging mechanism), and a pair of side locking pieces 250b. The main plate 210b is a generally rectangular plate, and it has a first face 211b (a first face of the second conductive part) and a second face 212b (a second face of the second conductive part) being the opposite face of the first face 211b. The first face 211b is to be brought into contact with the conductive fabric. A plurality of projections 213b of square pyramid shape are disposed in a zigzag manner on the first face 211b. As shown in FIG. 3B, the main plate 210b is placed on an inner face (i.e. the face facing the body 100a) of the body 100b so as to cover the front portion in the fore-and-aft direction D1 of the accommodating recess 111b. The first face 211b of the main plate 210b and the first face 211a of the main plate 210a are opposed to each other to each other so as to hold the conductive fabric therebetween. In addition, the second face 212b of the main plate 210b is exposed in its middle through the accommodating recess 111b.

The front plate 220b is provided at a distal end of the main plate 210b. The front plate 220b is bent substantially at a right angle to the main plate 210b and extends downward. The front plate 220b is inserted into the front slit 114b of the body 100b. The pair of side plates 230b are continuous with opposite ends of the front plate 220b. The side plates 230b are bent substantially at a right angle to the front plate 220b and extend to the rear side of the fore-and-aft direction D1. Two locking projections 231b of pointed shape, aligned in the fore-and-aft direction D1, extend to the conductive part 200a side (i.e. upward) from each of the side plates 230b. The locking projections 231b are located outside in the lateral direction D2 of the first face 211b of the main plate 210b, and they are insertable into the locking holes 214a of the conductive part 200a and further into the through holes 112a of the body 100a (see FIG. 2B). As shown in FIG. 3B, the side plates 230b are to be inserted into the front locking holes 112b of the body 100b, while the front protrusions 113b of the body 100b are to be locked in locking portions 232b, spaces between the locking projections 231b of the side plates 230b.

The step 240b is continuous with a rear end of the main plate 210b. The step 240b has an inclined plate 241b and a horizontal plate 242b. The inclined plate 241b extends at an angle to the main plate 210b and slopes downward to the rear side of the fore-and-aft direction D1 (see FIG. 2A). The middle portion of the inclined plate 241b is provided with a projected piece 241b1 (a second projection). The horizontal plate 242b is a rectangular plate continuous with a rear end of the inclined plate 241b, and it extends to the rear side of the fore-and-aft direction D1. The end portions in the lateral direction D2 of the inclined plate 241b and horizontal plate 242b are accommodated in the side recesses 115b of the body 100b, while the middle portions thereof are exposed through the accommodating recess 111b of the body 100b.

The pair of side locking pieces 250b are continuous with opposite ends of the horizontal plate 242b. The side locking pieces 250b are bent substantially at a right angle to the horizontal plate 242b and extend downward. The side locking pieces 250b have generally rectangular locking holes 251b in the center. As shown in FIG. 3B, the side locking pieces 250b are to be inserted into the rear locking holes 116b of the body 100b, while the rear protrusions 117b of the body 100b are to be locked in the locking holes 251b of the side locking pieces 250b. The side plates 230b are to be locked in the front locking holes 112b. The side locking pieces 250b are to be locked in the rear locking holes 116b, such that the conductive part 200b is fixed inside the body 100b.

The spring clip 300 (clamp of the biasing device) is a generally C-shaped metal plate having electrical conductivity as shown in FIGS. 1A to 1D, 2A, and 4. The spring clip 300 has a first arm 310, a second arm 320, and an intermediate portion 330. The intermediate portion 330 is a generally rectangular plate. The first arm 310 and the second arm 320 are plates each having a base end, an inclined portion, and a distal end. A distance in the fore-and-aft direction D1 from the distal end of the first arm 310 to a rear end face of the intermediate portion 330 is smaller than a length in the fore-and-aft direction D1 of the accommodating recess 111a of the body 100a, and a distance in the fore-and-aft direction D1 from the distal end of the second arm 320 to a rear end face of the intermediate portion 330 is smaller than a length in the fore-and-aft direction D1 of the accommodating recess 111b of the body 100b. In addition, each length in the lateral direction D2 of the first arm 310, the second arm 320, and the intermediate portion 330 is smaller than each length in the lateral direction D2 of the accommodating recesses 111a and 111b of the bodies 100a and 100b. That is, the first arm 310, the second arm 320, and the intermediate portion 330 can be accommodated in the accommodating recesses 111a and 111b in a locked state (to be described).

The base end of the first arm 310 is a plate continuous with an upper end of the intermediate portion 330 and provided with a semispherical operation protrusion 312, while the base end of the second arm 320 is a plate continuous with a lower end of the intermediate portion 330 and provided with a semispherical operation protrusion 322. The operation protrusions 312 and 322 are operable to elastically deform the spring clip 300 and open the first arm 310 and the second arm 320. The inclined portions of the first and second arms 310 and 320 are plates continuous with the base ends and are inclined in directions close to each other, and they are provided with rectangular holes 311 and 321 (first and second holes of the engaging mechanism), respectively.

The distal ends of the first and second arms 310 and 320 are plates continuous with the inclined portions and are curved in directions away from each other. The distance between the apexes of the distal ends of the first and second arms 310 and 320 is smaller than the sum of a thickness of the main plate 210a of the conductive part 200a, a thickness of the main plate 210b of the conductive part 200b, and a thickness of the conductive fabric. When the first and second arms 310 and 320 are inserted into the accommodating recesses 111a and 111b in the state where the conductive fabric is held between the main plate 210a of the conductive part 200a and the main plate 210b of the conductive part 200b, the first arm 310 and the second arm 320 climb over the pressing portions 111a1 and 111b1 and the steps 240a and 240b and elastically abut the second faces 212a and 212b of the main plates 210a and 210b. As a result, the conductive parts 200a and 200b are elastically held by the spring clip 300. In this state (hereinafter referred to as a locked state), the inclined portions of the first and second arms 310 and 320 are engaged with the steps 240a and 240b of the conductive parts 200a and 200b, and the projected pieces 241a1 and 241b1 of the steps 240a and 240b are engaged in the holes 311 and 321 of the first and second arms 310 and 320.

The following paragraphs describes in detail the steps of assembling the connector of the above configuration (except for steps of attaching the spring clip 300). The first step is to prepare the body 100a made by a known injection molding method and the conductive part 200a made by a known press molding method. The next step is to insert the side locking pieces 220a of the conductive part 200a into the associated locking slits 113a of the body 100, and to insert the front plate 230a of the conductive part 200a into the front slit 115a of the body 100a. Then, the protrusions 114a in the locking slits 113a are locked into the locking holes 221a of the side locking pieces 220a. At this time, the main plate 210a of the conductive part 200a is placed on the inner face (the face facing the body 100b) of the body 100a so as to cover the front portion of the accommodating recess 111a and the through holes 112a, and the ends of the inclined plate 241a of the conductive part 200a are accommodated in the side recesses 116a of the body 100a.In addition, the connecting portions 250a and the holding portions 260a of the conductive part 200a are placed between the hinge protrusions 120a of the body 100a.

Also prepared are the body 100b made by a known injection molding method and the conductive part 200b made by a known press molding method. Thereafter, the front plate 220b of the conductive part 200b is inserted into the front slit 114b of the body 100b, the side plates 230b of the conductive part 200b are inserted into the associated front locking holes 112b of the body 100b, and the side locking pieces 250b of the conductive part 200b are inserted into the associated rear locking holes 116b of the body 100b. Then, the front protrusions 113b inside the front locking holes 112b are locked into the locking portions 232b of the side plates 230b, and the rear protrusions 117b inside the rear locking holes 116b are locked into the locking holes 251b of the side locking pieces 250b. At this time, the main plate 210b is placed on the inner face of the body 100b so as to cover the front portion of the accommodating recess 111b, and the ends of the inclined plate 241b and the horizontal plate 242b (i.e. the ends of the step 240b) are accommodated in the side recesses 115b of the body 100b.

Thereafter, the hinge shafts 121b of the body 100b are fitted into the hinge holes 121a of the body 100a. Consequently, the bodies 100a and 100b are hinged in an openable and closable manner.

Thereafter, the bodies 100a and 100b are brought into the open state. Thereafter, the cable C is inserted into one of the insertion holes 122b of the body 100b, the associated hinge hole 121a and the insertion hole 122a of the body 100a, and the associated one of the holding portions 260a of the conductive part 200a, and the core wire of the cable C is inserted into at least one of the connecting portions 250a of the conductive part 200a. Thereafter, the holding portion 260a and the connecting portion 250a are swaged, so that the cable C is held in the holding portion 260a, and the core wire is held in and electrically connected to the connecting portion 250a. Thereafter, the core cable and the connecting portion 250a may be soldered together.

The following paragraphs describe how to connect the conductive fabric to the connector and how to attach the spring clip 300. First, the conductive fabric is inserted between the bodies 100a and 100b in the open state, and then the bodies 100a and 100b are closed. Then, the conductive fabric is sandwiched between the main plate 210a of the conductive part 200a and the main plate 210b of the conductive part 200b. At this time, the locking projections 231b of the conductive part 200b penetrate the conductive fabric and pass through the locking holes 214a of the conductive part 200a and into the through holes 112a of the body 100a.

Thereafter, the first and second arms 310 and 320 of the spring clip 300 are inserted into the accommodating recesses 111a and 111b of the bodies 100a and 100b, respectively. Then, the first and second arms 310 and 320 are pressed by the pressing portions 111a1 and 111b1 in the accommodating recesses 111a and 111b, and they elastically deform in the directions away from each other. When the first and second arms 310 and 320 climb over the pressing portions 111a1 and 111b1 and the steps 240a and 240b of the conductive parts 200a and 200b, the distal ends of the first and second arms 310 and 320 elastically abut the second faces 212a and 212b of the main plates 210a and 210b of the conductive parts 200a and 200b. Simultaneously, the first and second arms 310 and 320 are engaged with the steps 240a and 240b of the conductive parts 200a and 200b, and the projected pieces 241a1 and 241b1 of the steps 240a and 240b are engaged into the holes 311 and 321 of the f first and second arms 310 and 320. Consequently, the spring clip 300 is attached to the conductive parts 200a and 200b to elastically hold the conductive parts 200a and 200b holding the conductive fabric therebetween.

To detach the spring clip 300, the operation protrusions 312 and 322 are pressed to elastically deform and open the first and second arms 310 and 320. The deformed first and second arms 310 and 320 are disengaged from the steps 240a and 240b, and the projected pieces 241a1 and 241b1 of the steps 240a and 240b are disengaged from the holes 311 and 321 of the first arm 310 and the second arm 320. Thereafter, the spring clip 300 is pulled out of the accommodating recesses 111a and 111b of the bodies 100a and 100b.

Thereafter, the bodies 100a and 100b are pulled open. Then, the locking projections 231b of the conductive part 200b come out of the through holes 112a of the body 100a, the locking holes 214a of the conductive part 200a, and the conductive fabric. It is now possible to pull out the conductive fabric from between the main plate 210a of the conductive part 200a and the main plate 210b of the conductive part 200b.

In the connector as described above, when the main plate 210a of the conductive part 200a and the main plate 210b of the conductive part 200b hold the conductive fabric therebetween, the locking projections 231b of the conductive part 200b penetrate the conductive fabric and pass through the locking holes 214a of the conductive part 200a and into the through holes 112a of the body 100a. The conductive parts 200a and 200b, held by the spring clip 300, can keep securely holding the conductive fabric therebetween even when the conductive fabric is twisted.

Further, the present connector has an improved tension strength with respect to the conductive fabric because the locking projections 231b penetrate the conductive fabric and pass through the locking holes 214a of the conductive part 200a. The locking projections 231b received the locking holes 214a of the conductive part 200a are less likely to deform if placed under tension by the conductive fabric pulled. Further advantageously, the square pyramid shaped projections 213a and 213b of the first faces 211a and 211b of the conductive parts 200a and 200b elastically contact the conductive fabric, increasing the contact area of the first faces 211a and 211b of the conductive parts 200a and 200b with the conductive fabric. This increases friction resistance of the conductive parts 200a and 200b with respect to the conductive fabric, further improving the tension strength of the connector with respect to the conductive fabric. Further, the projections 213a and 213b of the conductive parts 200a and 200b elastically contact the conductive fabric to provide a stable contact resistance value with respect to the conductive fabric, improving the connection stability of the connector.

In addition, as the spring clip 300 is accommodated in the accommodating recesses 111a and 111b of the bodies 100a and 100b, it is possible to prevent the interference with the spring clip 300 from the outside of the bodies 100a and 100b. It is thus possible to prevent accidental disengagement of the spring clip 300 from the conductive parts 200a and 200b due to such interference from the outside.

Still advantageously, the connector is connected to the conductive fabric simply by the conductive parts 200a and 200b holding the conductive fabric therebetween, the locking projections 231b of the conductive part 200b penetrating the conductive fabric and passing through the locking holes 214a of the conductive part 200a and into the through holes 112a of the body 100a. With such configuration, it is easy to release the connection of the connector with the conductive fabric, simply by detaching the spring clip 300 and pulling open the bodies 100a and 100b. It is therefore easy to change the connection position of the connector with the conductive fabric, improving design flexibility. In addition, the spring clip 300 can be easily attached to and detached from the conductive parts 200a and 200b because it is possible to fix the spring clip 300 in position simply by having it climb over the steps 240a and 240b of the conductive parts 200a and 200b so as to be engaged with the steps 240a and 240b.

### Second Embodiment

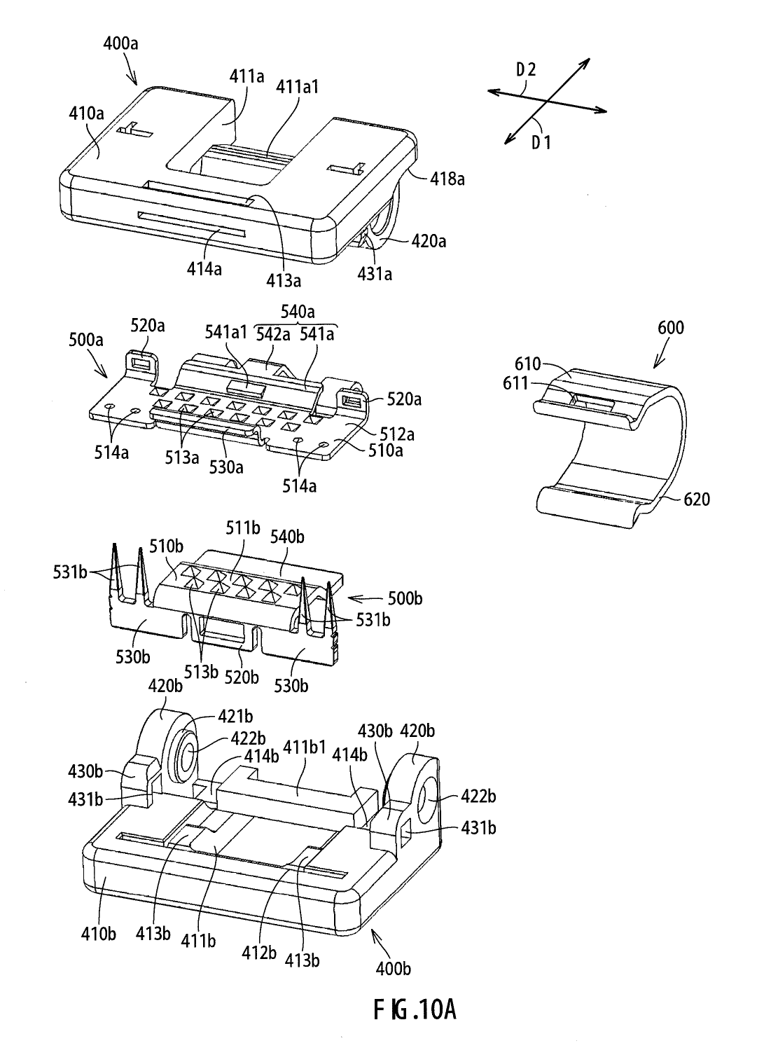

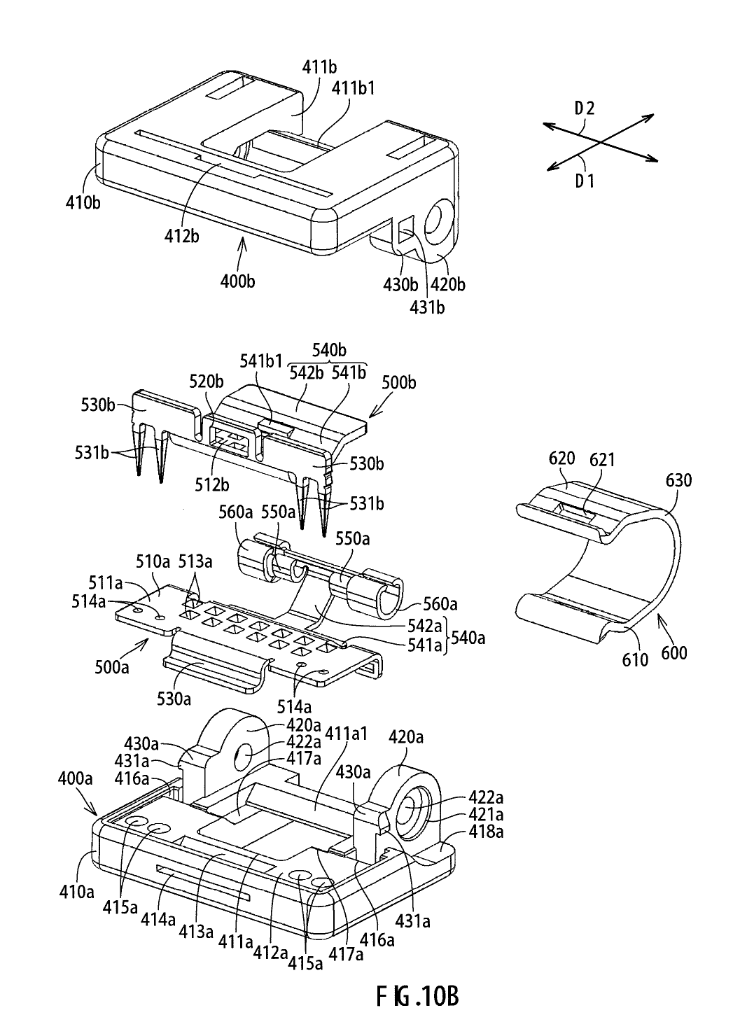

Next, a connector according to a second embodiment of the invention will be described with reference to FIGS. 9A to 11B. The connector herein is connectable to a flexible conductive fabric (electric conductor), not shown, and a cable C. As shown in FIGS. 9A and 9B, this connector includes bodies 400a and 400b (first and second bodies), conductive parts 500a and 500b (first and second conductive parts), and a spring clip 600 (biasing device). These elements of the connector will be described in detail below. It should be noted that FIGS. 9A, 10A, and 10B show directions D1 and D2 for the convenience of explanation of the second embodiment. D1 is a fore-and-aft direction of the connector, and D2 is a lateral direction that is orthogonal to the fore-and-aft direction D1.

The body 400a is an injection mold product made of an insulating resin as shown in FIGS. 9A to 11A. The body 400a has a generally rectangular block 410a, a pair of ring-shaped hinge protrusions 420a, and a pair of locking portions 430a. A rectangular accommodating recess 411a is formed in a center of the block 410a. The accommodating recess 411a passes through the block 410a in its thickness direction such that a rear side in the fore-and-aft direction D1 of the block 410a is open. A pressing portion 411a1 bridges rear ends of walls extending in the fore-and-aft direction D1 of the accommodating recess 411a. An upper face of the pressing portion 411a1 slopes downward to the rear side in the fore-and-aft direction D1. The pressing portion 411a1 is to be disposed on the rear side in the fore-and-aft direction D1 of a step 540a (to be described) of the conductive part 500a.

As shown in FIG. 10B, a generally rectangular attachment recess 412a is formed in the front end of the lower face of the block 410a. Toward the distal end in the fore-and-aft direction D1 of the accommodating recess 411a of the block 410a, there is formed a generally rectangular slit 413a extending from the bottom of the attachment recess 412a to the top of the block 410a. In front of the slit 413a of the block 410a, a generally rectangular lateral hole 414a extends orthogonally to and communicates with the slit 413a. On either side of the slit 413a of the block 410a, two cylindrical insertion holes 415a are arranged in alignment in the lateral direction D2. A pair of locking slits 416a is formed behind the opposite ends in the lateral direction D2 of the attachment recess 412a of the block 410a. The locking slits 416a each have a protrusions, not shown, on its front wall faces in the fore-and-aft direction D1. The walls in the lateral direction D2 of the accommodating recess 411a of the block 410a are formed with a pair of side recesses 417a, communicating with the accommodating recess 411a. In corners in the rear side in the fore-and-aft direction D1 of the block 410a, a pair of indention 418a is formed to avoid the interference of the block 410a with hinge protrusions 420b (to be described) of the body 400b.

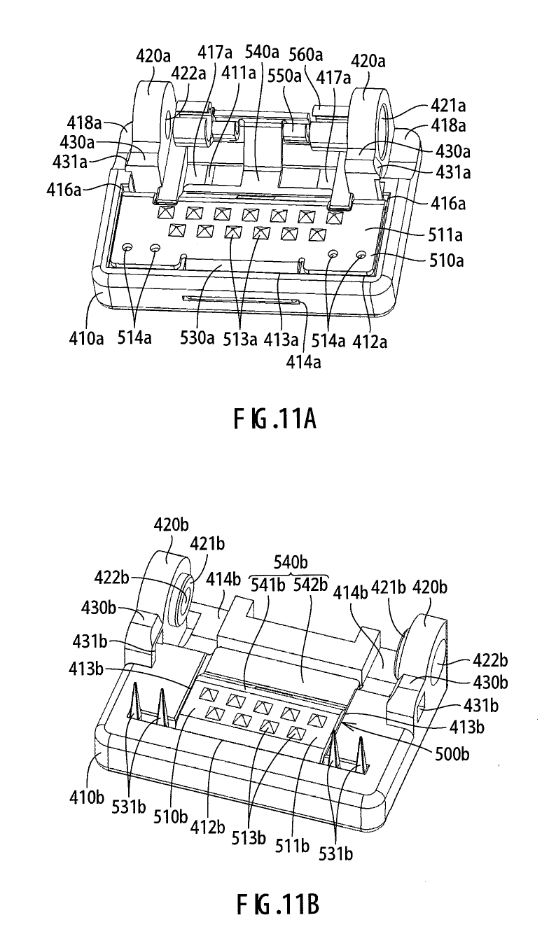

The pair of hinge protrusions 420a is located inside the indentions 418a in the rear end of the block 410a. The hinge protrusions 420a have substantially the same configuration as the hinge protrusions 120a of the first embodiment. FIGS. 10A to 11A show hinge holes 421a and insertion holes 422a. Further descriptions will be omitted to avoid redundancies. The locking portions 430a (locking mechanism), which are generally rectangular protrusions, are continuous with the front sides in the fore-and-aft direction D1 of the hinge protrusions 420a. Locking claws 431a are provided on outer faces of the locking protrusions 430a.

The body 400b is an injection mold product made of an insulating resin as shown in FIGS. 9A to 10B and 11B. The body 400b has a generally rectangular block 410b, the pair of ring-shaped hinge protrusions 420b, and a pair of locking portions 430b. A rectangular accommodating recess 411b is formed in the center of the block 410b. The accommodating recess 411b passes through the block 410b in its thickness direction such that a rear side in the fore-and-aft direction D1 of the block 410b is open. A pressing portion 411b1 bridges rear ends of walls extending in the fore-and-aft direction D1 of the accommodating recess 411b. A lower face of the pressing portion 411b1 slopes upward to the rear side in the fore-and-aft direction D1. The pressing portion 411b1 is to be disposed on the rear side in the fore-and-aft direction D1 of a step 240b (to be described) of the conductive part 500b.

A generally rectangular locking slit 412b passes through the block 410b in the thickness direction, in a front portion in the fore-and-aft direction D1 of the accommodating recess 411b of the block 410b. A protrusion, not shown, is provided centrally on the rear wall in the fore-and-aft direction D1 of the locking slit 412b. The walls in the lateral direction D2 of the accommodating recess 411b of the block 410b are formed with a pair of side recesses 413b, communicating with the accommodating recess 411b. The side recesses 413b each have a step with its riser sloping downward to the rear side in the fore-and-aft direction D1.

The pair of hinge protrusions 420b are located at the rear corners in the fore-and-aft direction D1 of the block 410b. Inside the hinge protrusions 420b of the block 410b, a pair of hollows 414b is formed to avoid the interference of the block 410b with the hinge protrusions 420a of the body 400a.

The hinge protrusions 420b have substantially the same configuration as the hinge protrusions 120b of the first embodiment. FIGS. 10A, 10B, and 11B show hinge shafts 421b and insertion holes 422b. Further descriptions will be omitted to avoid redundancies. When the hinge shafts 421b fit into the hinge holes 421a of the hinge protrusions 420a, the bodies 400a and 400b will be hinged together openably and closably. FIG. 9A shows a closed state of the bodies 400a and 400b (that is, a closed state of the connector), and FIG. 9B shows an open state of the bodies 400a and 400b (that is, an open state of the connector). The locking portions 430b (locking mechanism), which are generally rectangular protrusions, are continuous with the front sides in the fore-and-aft direction D1 of the hinge protrusions 420b. The distance between inner faces of the locking protrusions 430b is slightly smaller than the distance between outer faces of the locking protrusions 430a. The locking protrusions 430b have locking holes 431b passing through the locking protrusions 430b in the lateral direction D2. In the closed state, the locking holes 431b may lockingly receive the locking claws 431a of the locking portions 430a.

As shown in FIGS. 10A to 11B, the conductive part 500a is configured of a metal plate having electrical conductivity. The conductive part 500a has a main plate 510a, a pair of side locking pieces 520a, a front locking piece 530a, the step 540a (a first step of an engaging mechanism), a pair of connecting portions 550a, and a pair of holding portions 560a. The main plate 510a is a generally rectangular plate, and it has a first face 511a (a first face of the first conductive part), and a second face 512a (a second face of the first conductive part) being the opposite face of the first face 511a. The first face 511a is to be brought into contact with the conductive fabric. A plurality of projections 513a of square pyramid shape are disposed in a zigzag manner in the middle of the first face 511a. As shown in FIG. 11A, the main plate 510a is accommodated in the attachment recess 412a of the body 400a so as to cover the front portion in the fore-and-aft direction D1 of the accommodating recess 411a and the insertion holes 415a. Two locking holes 514a, aligned in the lateral direction D2, are formed in each end in the lateral direction D2 of the main plate 510a (each end of the first face 511a). The locking holes 514a communicate with the associated insertion holes 415a. The second face 512a of the main plate 510a is exposed in the center through the accommodating recess 411a.

The main plate 510a is provided in its front center with the front locking piece 530a and in its rear center with the step 540a. The pair of side locking pieces 520a are provided at opposite ends of the rear end of the main plate 510a. The front locking piece 530a is a substantially L-shaped member that is bent substantially at a right angle to the main plate 510a. The front locking piece 530a is to be inserted into the slit 413a of the body 400a, and a front end of the front locking piece 530a is to be locked in the lateral hole 414a. The side locking pieces 520a are bent substantially at a right angle to the main plate 510a and extend upward. The side locking pieces 520a are provided with generally rectangular locking holes. The side locking pieces 520a are to be inserted into the locking slits 416a of the body 400a, such that the locking holes of the side locking pieces 520a lockingly receive the protrusions inside the locking slits 416a of the body 400a. As a result, the front locking piece 530a is locked in the lateral hole 414a, and the side locking pieces 520a are locked in the locking slits 416a of the body 400a, such that the conductive part 500a is fixed inside the body 400a.

The step 540a has substantially the same configuration as the step 240a of the first embodiment. FIGS. 9B to 11A show an inclined plate 541a, a projected piece 541a1 (a first projection), and an arm plate 542a. Further descriptions will be omitted to avoid redundancies. The inclined plate 541a is accommodated at its end portions in the lateral direction D2 in the side recesses 417a of the body 400a and exposed in its middle portion through the accommodating recess 411a of the body 400a. The arm plate 542a is also exposed through the accommodating recess 411a.

The connecting portions 550a have substantially the same configuration as the connecting portions 250a of the first embodiment. The holding portions 560a have substantially the same configuration as the holding portions 260a of the first embodiment. Accordingly, further descriptions will be omitted to avoid redundancies.

As shown in FIGS. 9B to 10B and 11B, the conductive part 500b is configured of a metal plate having electrical conductivity. The conductive part 500b has a main plate 510b, a front locking piece 520b, a pair of side plates 530b, and a step 540b (a second step of the engaging mechanism). The main plate 510b is a generally rectangular plate, and it has a first face 511b (a first face of the second conductive part), and a second face 512b (a second face of the second conductive part) being the opposite face of the first face 511b. The first face 511b is to be brought into contact with the conductive fabric. A plurality of projections 513b of square pyramid shape are disposed in a zigzag manner on the first face 511b. As shown in FIG. 11B, ends in the lateral direction D2 of the main plate 510b are accommodated in the side recesses 413b of the body 400b such that the main plate 510b covers the front portion in the fore-and-aft direction D1 of the accommodating recess 411b. The first face 511b of the main plate 510b and the first face 511a of the main plate 510a are opposed to each other so as to hold the conductive fabric therebetween. In addition, the second face 512b of the main plate 510b is exposed in the middle through the accommodating recess 411b.

The front locking piece 520b is provided centrally on a front end of the main plate 510b. The front locking piece 520b is bent substantially at a right angle to the main plate 510b and extends downward. The front locking piece 520b has a generally rectangular locking hole. The front locking piece 520b is to be inserted into the locking slit 412b of the body 400b, the locking hole of the front locking piece 520b is to lockingly receive the protrusion inside the locking slit 412b of the body 400b. The pair of side plates 530b are continuous with opposite ends of the front end of the main plate 510b. The side plates 530b are bent substantially at a right angle to the main plate 510b and extend in the lateral direction D2. A pair of press-in pieces are provided on outer ends of the side plates 530b. The distance between the distal ends of the press-in pieces is slightly larger than the width in the lateral direction D2 of the locking slit 412b. That is, the side plates 530b and the front locking piece 520b are to be inserted into the locking slit 412b, and the press-in pieces are to be locked against the inner walls in the lateral direction D2 of the locking slit 412b. As a result, the front locking piece 520b and the side plates 530b are locked in the locking slit 412b, such that the conductive part 500b is fixed inside the body 400b.

Two locking projections 531b, aligned in the lateral direction D2, extend to the conductive part 500a side (i.e. upward) from each of the side plates 530b. The locking projections 531b located outside in the lateral direction D2 of the first face 511b of the main plate 510b, and they are insertable into the locking holes 514a of the conductive part 500a and further into the insertion holes 415a of the body 400a.

The step 540b has substantially the same configuration as the step 240b of the first embodiment. FIGS. 10A, 10B, and 11B show an inclined plate 541b, a projected piece 541b1 (a second projection), and a horizontal plate 542b. Further descriptions will be omitted to avoid redundancies. The end portions in the lateral direction D2 of the inclined plate 541b and the horizontal plate 542b are accommodated in the side recesses 413b of the body 100b, while the middle portions thereof are exposed through the accommodating recess 411b of the body 400b.

The spring clip 600 (clamp of the biasing device) is a generally C-shaped metal plate having electrical conductivity as shown in FIGS. 10A and 10B. The spring clip 600 has a first arm 610, a second arm 620, and an intermediate portion 630. The intermediate portion 630 is a plate curved generally in an arc shape. The first arm 610 and the second arm 620 have substantially the same configuration as the first arm 310 and the second arm 320, except that the first arm 610 and the second arm 620 do not have the operation protrusions 312 and 322. FIGS. 10A and 10B show holes 611 and 621 (first and second holes of the engaging mechanism).

The following paragraphs describes in detail the steps of assembling the connector of the above configuration (except for steps of attaching the spring clip 600). The first step is to prepare the body 400a made by a known injection molding method and the conductive part 500a made by a known press molding method. The next step is to insert the front locking piece 530a of the conductive part 500a into the slit 413a of the body 400a, and to lock the front end of the front locking piece 530a in the lateral hole 414a. Simultaneously, the side locking pieces 520a of the conductive part 500a are inserted into the associated locking slits 416a of the body 400a. Then, the protrusions inside the locking slits 416a of the body 400a are locked into the locking holes of the side locking pieces 520a. Also, the main plate 510a of the conductive part 500a is accommodated in the attachment recess 412a of the body 400a, and the ends of the inclined plate 541a of the conductive part 500a are accommodated in the side recesses 417a of the body 400a. The connecting portions 550a and the holding portions 560a of the conductive part 500a are placed between the hinge protrusions 420a of the body 400a.

Also prepared are the body 400b made by a known injection molding method and the conductive part 500b made by a known press molding method. Thereafter, the front locking piece 520b and the side plates 530b of the conductive part 500b are pressed into the locking slit 412b of the body 400b. Then, the protrusion inside the locking slit 412b of the body 400b is locked into the locking hole of the front locking piece 520b, and the press-in pieces of the side plates 530b are locked against the inner walls of the locking slit 412b. At this time, the ends of the main plate 510b and the step 540b are accommodated in the side recesses 413b of the body 400b.

Thereafter, the hinge shafts 421b of the body 400b are fitted into the associated hinge holes 421a of the body 400a. Consequently, the bodies 400a and 400b are hinged openably and closably. Thereafter, the bodies 400a and 400b are brought into the open state, and as in the first embodiment, a core wire of the cable C is electrically connected to the connection portion 550a and the cable C is held in the holding portion 560a.

The following paragraphs describe how to connect the conductive fabric to the connector and how to attach the spring clip 600. First, the conductive fabric is inserted between the bodies 400a and 400b in the open state, and the bodies 400a and 400b are closed. Then, the conductive fabric is sandwiched between the main plate 510a of the conductive part 500a and the main plate 510b of the conductive part 500b. At this time, the locking projections 531b of the conductive part 500b penetrate the conductive fabric and pass through the locking holes 514a of the conductive part 500a and into the insertion holes 415a of the body 400a. Simultaneously, the locking claws 431a of the locking portions 430a are locked into the locking holes 431b of the locking portions 430b, and the bodies 400a and 400b are temporarily fixed in the closed state.

Thereafter, the first and second arms 610 and 620 of the spring clip 600 are inserted into the accommodating recesses 411a and 411b of the bodies 400a and 400b, respectively. Then, the first and second arms 610 and 620 are pressed by the pressing portions 411a1 and 411b1 in the accommodating recesses 411a and 411b, and they elastically deform in the directions away from each other. When the first and second arms 610 and 620 climb over the pressing portions 411a1 and 411b1 and the steps 540a and 540b of the conductive parts 500a and 500b, the distal ends of the first and second arms 610 and 620 elastically abut the second faces 512a and 512b of the main plates 510a and 510b of the conductive parts 500a and 500b. Simultaneously, the first and second arms 610 and 620 are engaged with the steps 540a and 540b of the conductive parts 500a and 500b, and the projected pieces 541a1 and 541b1 of the steps 540a and 540b are engaged in the holes 611 and 621 of the first and second arms 610 and 620. Consequently, the spring clip 600 is attached to the conductive parts 500a and 500b to elastically hold the conductive parts 500a and 500b holding the conductive fabric therebetween.

To detach the spring clip 600, the first and second arms 610 and 620 are elastically deformed open. The first arm 610 and the second arm 620 are thus disengaged from the steps 540a and 540b, and the projected pieces 541a1 and 541b1 of the steps 540a and 540b are also disengaged from the holes 611 and 621 of the first and second arms 610 and 620. Thereafter, the spring clip 600 is pulled out from the accommodating recesses 411a and 411b of the bodies 400a and 400b.

Thereafter, the bodies 400a and 400b are pulled open. Then, the locking projections 531b of the conductive part 500b come out of the locking holes 514a of the conductive part 500a, the insertion holes 415a of the body 400a, and the conductive fabric; while the locking claws 431a of the locking portions 430a get disengaged from the locking holes 431b of the locking portions 430b. It is now possible to pull out the conductive fabric from between the main plate 510a of the conductive part 500a and the main plate 510b of the conductive part 500b.

The connector of the above embodiment provides the same advantageous effects as the connector of the first embodiment. Further advantageously, the locking portions 430a and 430b are provided near the hinge portions 420a and 420b, reducing the possibility of inadvertent release of the above-mentioned temporary fixation by the locking portions 430a and 430b.

The present invention is not limited to connectors of the first and second embodiments but may be modified in design within the scope of claims. Design modification examples of the connector will be described below in detail.

The first and second conductive parts may be configured like the conductive parts 200a and 200b/500a and 500b of the first and second embodiments that are metal plates having electrical conductivity. The first and second conductive parts of the invention may be modified in design as long as they are made of materials having electrical conductivity, are opposed to each other, and can hold therebetween a flexible electric conductor such as a conductive fabric. For example, the first and second conductive parts may be conductive metals manufactured by a casting method, or they may be fabricated by evaporating metals having electrical conductivity onto outer faces of resin members.

The invention is not limited to the cases of the first and second embodiments where the locking holes 214a/514a are provided in the main plate 210a/510a of the conductive part 200a/500a and where the locking projections 231b/531b are provided on the side plates 230b/530b of the conductive part 200b/500b. The invention requires at least one locking hole, which may be provided anywhere in at least one of the first conductive part and the first body, and at least one locking projection of pointed shape, which may be provided in at least one of the second conductive part and the second body, at such a location as to be received in the locking hole. The locking hole may be a locking recess.

The locking projection may be provided with a barb. In this case, when the locking projection with a barb penetrates a flexible electric conductor such as a conductive fabric, the barb serves to prevent the locking projection from falling off of the electric conductor. Therefore, the locking projection is less likely to fall off of the electric conductor, further improving a tension strength of the connector with respect to the electric conductor. In addition, the barb may be locked into the locking hole or recess. In this case, with the barb locked in the locking hole or recess, the first and second conductive parts are maintained in a state of holding the electric conductor, further improving the tension strength of the connector with respect to the electric conductor.

The invention is not limited to the cases of the first and second embodiments where the projections 214a and 214b/514a and 514b of square pyramid shape are provided on the first faces 211a and 211b/511a and 511b of the conductive parts 200a and 200b/500a and 500b. For example, the projections may be omitted if sufficient electrical continuity can be obtained by just bringing the first and second conductive plates into surface contact with the electric conductor. The projections may be of square pyramid shape or any other convex shapes, such as triangular pyramid shapes and cut-and-raised teeth as used in graters.

The invention is not limited to the cases of the first and second embodiments where the conductive part 200a/500a has the connecting portions 250a/550a. The connector of the invention may include a connecting portion of any shape that may be provided in at least one of the first and second conductive parts and may be connectable to the cable. Further, The invention is not limited to the cases of the first and second embodiments where the conductive part 200a/500a has the holding portions 260a/560a. The connector of the invention may include a holding portion of any shape that may be provided in at least one of the first and second conductive parts and may hold a cable. The connecting portion may be omitted if the connector of the invention is not for connection with a cable. The holding portion may also be omitted if the connector of the invention is not for connection with a cable, or if the cable can be securely fixed to the connecting portion or any other member.

The invention is not limited to the cases of the first and second embodiments where the spring clip 300/600 (the clamp of the biasing device) is a generally C-shaped conductive plate. The biasing device of the invention may have any configuration as long as it is generally C-shaped and adapted to hold the first and second conductive parts holding the electric conductor therebetween. The spring clip 300/600 may or may not be electrically conductive and may or may not include a clamp of generally C made of resin. The biasing device may directly or indirectly hold the conductive parts 200a and 200b/500a and 500b. For example, the spring clip 300/600 may hold the bodies 100a and 100b/400a and 400b so that the spring clip 300/600 can indirectly holds the conductive parts 200a and 200b/500a and 500b.

The engaging mechanism of the invention is not limited to the ones according to the first and second embodiments, including the steps 240a and 240b/540a and 540b of the conductive parts 200a and 200b/500a and 500b for engagement with the first and second arms 310 and 320/610 and 620, the projected pieces 241a1 and 241b1/541a1 and 541b1 of the steps 240a and 240b/540a and 540b, and the holes 311 and 321/611 and 621 of the first and second arms 310 and 320/610 and 620 for engagement with the projected pieces 241a1 and 241b1/541a1 and 541b1. For example, the engaging mechanism may only include steps configured to engage with the first and second arms. Alternatively, the engaging mechanism may include first and second projections provided in the first and second conductive parts, respectively, and first and second holes provided in the first and second arms, respectively; or the engaging mechanism may include first and second holes provided in the first and second conductive parts, respectively, and first and second holes provided in the first and second arms, respectively. In either of these two cases, the first and second projections may engage in the first and second holes. In addition, the engaging mechanism may be recesses configured to engage the first and second arms. Further, the engaging mechanism to engage the biasing device may be provided in the first and second bodies.

The bodies of the invention is not limited to the cases of the first and second embodiments where the bodies 100a and 100b/400a and 400b are hinged together openably and closably. For example, the first body with the first conductive part fixed thereto may be separately provided from the second body with the second conductive part fixed thereto, in which case the first and second bodies may be combined when the urging device holds the first and second conductive parts. Further, the first and second bodies can be omitted. In this case, the present invention may be modified such that the first and second conductive parts are hinged together openably and closably, or alternatively, the first and second conductive parts may be provided separately and combined when sandwiched by the biasing device.

The invention is not limited to the cases of the first and second embodiments where the accommodating recesses 111a and 111b/411a and 411b are formed the bodies 100a and 100b/400a and 400b, respectively. If the biasing device indirectly holds the first and second conductive parts via the first and second bodies as described above, the accommodating recesses are unnecessary. In addition, as in the first and second embodiments, the spring clip 300/600 may be entirely accommodated in the accommodating recesses 111a and 111b/411a and 411b, but the accommodating recesses may have such a shape as to accommodate a portion of the spring clip or any other biasing device.

The invention is not limited to the cases of the first and second embodiments where the hinge holes 121a/421a and the insertion holes 122a/422a are formed in the hinge protrusions 120a/420a of the body 100a/400a. At least one hinge hole will suffice. The hinge holes may be omitted if the cable C is connected to the connecting portion at a different location. In addition, the invention is not limited to the cases of the first and second embodiments where the receiving holes 122b/422b pass in the lateral direction D2 through the hinge protrusions 120b/420b of the body 100b/400b. The receiving holes may be omitted if the cable C is connected to the connecting portion at a different location. In addition, the hinge protrusions 120a/420a may be provided with hinge shafts and the hinge protrusions 120b/420b may be provided with hinge holes. If the first and second bodies are not hinged together, the hinge protrusions, the hinge holes, and the hinge shafts may be omitted. In addition, the hinge protrusions, the hinge holes, and the hinge shafts may be provided in the first and second conductive parts, and the first and second conductive parts may be hinged together as described above.

The locking mechanism may include the locking portions 430a provided in front of the hinge protrusions 420a, the locking claws 431a provided on the outer faces of the locking protrusions 430a, the locking portions 430b provided in front of the hinge protrusions 420b, and the locking holes 431b provided in the locking protrusions 430b as in the second embodiment. However, the locking mechanism may be any mechanism for locking the first body with the second body in the state where the first and second conductive parts hold the electric conductor therebetween. For example, the locking mechanism may include locking claws provided on one of the first and second bodies, and locking holes or recesses provided in the other of the first and second bodies to lock the locking claws in the state where the first and second conductive parts hold the electric conductor therebetween.

The invention is not to be considered as limited by the first and second embodiments, for which the materials, shapes, dimensions, arrangements, etc. of the respective elements are described by way of example only, and they may be modified in design in any manner as long as they provide similar functions. Also, the electric conductor may be a flexible conductive fabric as in the first and second embodiments above, but the connector of the invention is also applicable to connection with any other electric conductor including conductive sheets and locating tapes.

### REFERENCE SIGNS LIST

| 100a | Body (first body) | | |
|---|---|---|---|
| | 110a | Block | |
| | | 111a | Accommodating recess (first accommodating recess) |
| | 120a | Hinge protrusion | |
| | | 121a | Hinge hole |
| | | 122a | Insertion hole |
| 100b | Body (second body) | | |
| | 110b | Block | |
| | | 111b | Accommodating recess (first accommodating recess) |
| | 120b | Hinge protrusion | |
| | | 121b | Hinge shaft |
| | | 122b | Insertion hole |
| 200a | Conductive part (first conductive part) | | |
| | 210a | Main plate | |
| | | 211a | First face (first face of first conductive part) |
| | | 212a | Second face (second face of first conductive part) |
| | | 213a | Projection |
| | | 214a | Locking hole |
| | 220a | Side locking piece | |
| | 230a | Front plate | |
| | 240a | Step (first step of engaging mechanism) | |
| | | 241a1 | Projected piece (first projection of engaging |
| | | | mechanism) |
| | 250a | Connecting portion | |
| | 260a | Holding portion | |
| 200b | Conductive part (second conductive part) | | |
| | 210b | Main plate | |
| | | 211b | First face (first face of second conductive part) |
| | | 212b | Second face (second face of second conductive part) |
| | | 213b | Projection |
| | 220b | Front plate | |
| | 230b | Side plate | |
| | | 231b | Locking projection |
| | 240b | Step (second step of engaging mechanism) | |
| | | 241b1 | Projected piece (second projection of engaging |
| | | | mechanism) |
| | 250b | Side locking piece | |
| 300 | Spring clip (clamp of biasing device) | | |
| | 310 | First arm | |
| | | 311 | Hole (first hole of engaging mechanism) |
| | 320 | Second arm | |
| | | 321 | Hole (second hole of engaging mechanism) |
| 400a | Body (first body) | | |
| | 410a | Block | |
| | | 411a | Accommodating recess (first accommodating recess) |
| | 420a | Hinge protrusion | |
| | | 421a | Hinge hole |
| | | 422a | Insertion hole |
| | 430a | Locking portion (locking mechanism) | |
| | | 431a | Locking claw |
| 400b | Body (second body) | | |
| | 410b | Block | |
| | | 411b | Accommodating recess (first accommodating recess) |
| | 420b | Hinge protrusion | |
| | | 421b | Hinge shaft |
| | | 422b | Insertion hole |
| | 430b | Locking portion (locking mechanism) | |
| | | 431b | Locking hole |
| 500a | Conductive part (first conductive part) | | |
| | 510a | Main plate | |
| | | 511a | First face (first face of first conductive part) |
| | | 512a | Second face (second face of first conductive part) |
| | | 513a | Projection |
| | | 514a | Locking hole |
| | 520a | Side locking piece | |
| | 530a | Front locking piece | |
| | 540a | Step (first step of engaging mechanism) | |
| | | 541a1 | Projected piece (first projection of engaging |
| | | | mechanism) |
| | 550a | Connecting portion | |
| | 560a | Holding portion | |
| 500b | Conductive part (second conductive part) | | |
| | 510b | Main plate | |
| | | 511b | First face (first face of second conductive part) |
| | | 512b | Second face (second face of second conductive part) |
| | | 513b | Projection |
| | 520b | Side locking piece | |
| | 530b | Side plate | |
| | | 531b | Locking projection |
| | 540b | Step (second step of engaging mechanism) | |
| | | 541b1 | Projected piece (second projection of engaging |
| | | | mechanism) |
| 600 | Spring clip (clamp of biasing device) | | |
| | 610 | First arm | |
| | | 611 | Hole (first hole of engaging mechanism) |
| | 620 | Second arm | |
| | | 621 | Hole (second hole of engaging mechanism) |

1. A connector comprising:
first and second conductive parts that are opposed to each other so as to hold a flexible electric conductor therebetween, the first conductive part including a locking hole or locking recess, the second conductive part including a locking projection of pointed shape, the locking projection being configured to pass through the electric conductor and be received in the locking hole or locking recess when the first and second conductive parts hold the electric conductor; and
a biasing device including a clamp of generally C shape to hold the first and second conductive parts holding the electric conductor.

2. A connector comprising:
first and second conductive parts that are opposed to each other so as to hold a flexible electric conductor therebetween;
first and second bodies fixed to the first and second conductive parts, respectively; and
a biasing device including a clamp of generally C shape to hold the first and second conductive parts holding the electric conductor, wherein at least one of the first body and the first conductive part has a locking hole or locking recess, and
at least one of the second body and the second conductive part has a locking projection of pointed shape, the locking projection being configured to pass through the electric conductor and be received in the locking hole or locking recess when the first and second conductive parts hold the electric conductor.

3. The connector according to claim 1, further comprising:
first and second bodies fixed to the first and second conductive parts, respectively,
wherein the first and second bodies are provided with first and second accommodating recesses, respectively, to accommodate the biasing device.

4. The connector according to claim 2,
wherein the first and second bodies are provided with first and second accommodating recesses, respectively, to accommodate the biasing device.

5. The connector according to claim 1, further comprising an engaging mechanism, wherein
the first and second conductive parts each further include a first face, being abuttable on the electric conductor, and a second face, being an opposite face of the first face,
the clamp includes first and second arms being elastically abuttable on the second faces of the first and second conductive parts, respectively, and
the engaging mechanism is configured to engage the first and second arms with the first and second conductive parts, respectively, in a state where the first and second arms elastically abut the second faces of the first and second conductive parts.

6. The connector according to claim 2, further comprising an engaging mechanism, wherein
the first and second conductive parts each further include a first face, being abuttable on the electric conductor, and a second face, being an opposite face of the first face,
the clamp includes first and second arms being elastically abuttable on the second faces of the first and second conductive parts, respectively, and
the engaging mechanism is configured to engage the first and second arms with the first and second conductive parts, respectively, in a state where the first and second arms elastically abut the second faces of the first and second conductive parts.

7. The connector according to claim 5, wherein
the engaging mechanism includes first and second steps, the first and second steps being provided in the first and second conductive parts, respectively, and configured to engage with the first and second arms, respectively.

8. The connector according to claim 6, wherein
the engaging mechanism includes first and second steps, the first and second steps being provided in the first and second conductive parts, respectively, and configured to engage with the first and second arms, respectively.

9. The connector according to claim 5, wherein
the engaging mechanism includes first and second projections provided in the first and second conductive parts, respectively, and first and second holes provided in the first and second arms, respectively,
or alternatively, the engaging mechanism includes first and second holes provided in the first and second conductive parts, respectively, and first and second projections provided in the first and second arms, respectively,
wherein the first and second projections are configured to engage with the first and second holes.

10. The connector according to claim 6, wherein
the engaging mechanism includes first and second projections provided in the first and second conductive parts, respectively, and first and second holes provided in the first and second arms, respectively,
or alternatively, the engaging mechanism includes first and second holes provided in the first and second conductive parts, respectively, and first and second projections provided in the first and second arms, respectively,
wherein the first and second projections are configured to engage with the first and second holes.

11. The connector according to claim 1, wherein
at least one of the first and second conductive parts further comprises a connecting portion that is connectable to a cable.

12. The connector according to claim 11, further comprising:
first and second bodies that are hinged together openably and closably and fixed to the first and second conductive parts, respectively, wherein
the first body includes a hinge shaft and the second body includes a hinge hole, or alternatively the first body includes a hinge hole and the second body includes a hinge shaft,
the hinge shaft is of a tubular shape such as to fit in the hinge hole, and
the hinge shaft and the hinge hole are configured to allow the cable to pass therethrough so as to connect the cable with the connecting portion.

13. The connector according to claim 2, wherein
at least one of the first and second conductive parts further comprises a connecting portion that is connectable to a cable.

14. The connector according to claim 13, wherein
the first body includes a hinge shaft and the second body includes a hinge hole, or alternatively the first body includes a hinge hole and the second body includes a hinge shaft,
the hinge shaft is of a tubular shape such as to fit in the hinge hole, and
the hinge shaft and the hinge hole are configured to allow the cable to pass therethrough so as to connect the cable with the connecting portion.

15. The connector according to claim 11, wherein
at least one of the first and second conductive parts further includes a holding portion to hold the cable.

16. The connector according to claim 13, wherein
at least one of the first and second conductive parts further includes a holding portion to hold the cable.

17. The connector according to claim 5, wherein
the first faces of the first and second conductive parts are provided with projections.

18. The connector according to claim 6, wherein
the first faces of the first and second conductive parts are provided with projections.

19. The connector according to claim 17, wherein
the projections are of square pyramid shape.

20. The connector according to claim 18, wherein
the projections are of square pyramid shape.

21. The connector according to claim 5, wherein
the locking projection comprises a plurality of locking projections arranged outside the first face of the second conductive part, and
the locking hole or locking recess comprises a plurality of locking holes or locking recess arranged in opposite outer ends of the first face of the first conductive part.

22. The connector according to claim 6, wherein
the locking projection comprises a plurality of locking projections arranged outside the first face of the second conductive part, and
the locking hole or locking recess comprises a plurality of locking holes or locking recess arranged in opposite outer ends of the first face of the first conductive part.

23. The connector according to claim 1, wherein
the locking projection is provided with a barb.

24. The connector according to claim 2, wherein
the locking projection is provided with a barb.

25. The connector according to claim 1, further comprising:
first and second bodies fixed to the first and second conductive parts, respectively; and
a locking mechanism to lock the first body with the second body in the state where the first and second conductive parts hold the electric conductor therebetween.

26. The connector according to claim 2, further comprising:
a locking mechanism to lock the first body with the second body in the state where the first and second conductive parts hold the electric conductor therebetween.

27. The connector according to claim 25, wherein the locking mechanism include:
a locking claw provided on one of the first and second bodies, and
a locking hole or locking recess formed in the other of the first and second bodies and configured to lock the locking claw in the state where the first and second conductive parts hold the electric conductor therebetween.

28. The connector according to claim 26, wherein the locking mechanism include:
a locking claw provided on one of the first and second bodies, and
a locking hole or locking recess formed in the other of the first and second bodies and configured to lock the locking claw in the state where the first and second conductive parts hold the electric conductor therebetween.
